(19) United States
(12) Patent Application Publication
(10) Pub. No.: US 2008/0117877 A1
(43) Pub. Date: May 22, 2008

(54) APPARATUS AND METHOD FOR PERFORMING EFFECTIVE AUTOMATIC REPEAT REQUEST IN MULTI-HOP RELAY SYSTEM

(75) Inventors: Chan-Ho MIN, Yongin-si (KR); Jong-Hyung KWUN, Seongnam-si (KR); Dong-Ho CHO, Seoul (KR); Ju-Yeop KIM, Anyang-si (KR); Sik CHOI, Daejeon-city (KR); Ho-Won LEE, Chungjoo-si (KR); Hyu-Dae KIM, Daejeon-city (KR)

Correspondence Address: Jefferson IP Law, LLP, 1730 M Street, NW, Suite 807, Washington, DC, 20036, US

(73) Assignees: SAMSUNG ELECTRONICS CO., LTD., Suwon-city (KR); KOREA ADVANCED INSTITUTE OF SCIENCE AND TECHNOLOGY, Daejeon-city (KR)

(21) Appl. No.: 11/942,224

(22) Filed: Nov. 19, 2007

(30) Foreign Application Priority Data
Nov. 17, 2006 (KR) 10-2006-0113618

(51) Int. Cl. H04Q 7/00

(52) U.S. Cl. 370/331

(57) ABSTRACT

An apparatus and method for performing effective Automatic Repeat reQuest (ARQ) in a multi-hop relay system is provided. The method includes the steps of determining whether a Mobile Station (MS) enters a handover region; if it is determined that the MS enters the handover region, transmitting an E2E-ARQ-Request message, which provides a notification that an End-to-End (E2E) ARQ method has begun to be used, to at least one of a Relay Station (RS) and the MS, transmitting to the RS an ARQ block to be transmitted to the MS, and storing the ARQ block in a queue; and if an Acknowledgement (ACK) for the ARQ block is received from the RS and if an E2E ACK which provides a notification that the MS has received the ARQ block is received from the at least one of the RS and the MS, discarding the ARQ block from the queue. Thus, excellent throughput and Media Access Control (MAC) efficiency can be obtained.

### PRIORITY

This application claims the benefit under 35 U.S.C. § 119(a) of a Korean patent application filed on Nov. 17, 2006 in the Korean Intellectual Property Office and assigned Serial No. 2006-0113618, the entire disclosure of which is hereby incorporated by reference.

### JOINT RESEARCH AGREEMENT

The claimed invention was made by, on behalf of, and/or in connection with one or more of the following parties to a joint research agreement between Samsung Electronics Co., Ltd. and the Korea Advanced Institute of Science and Technology. The agreement was in effect on and before the date the claimed invention was made, and the claimed invention was made as a result of activities undertaken within the scope of the agreement.

### BACKGROUND OF THE INVENTION

1. Field of the Invention

The present invention relates to Automatic Repeat reQuest (ARQ). More particularly, the present invention relates to an apparatus and method for performing effective ARQ in a multi-hop relay system.

2. Description of the Related Art

In next generation mobile communication networks, unlike conventional cellular networks utilizing a Base Station (BS), a Relay Station (RS) is used to connect a BS and a Mobile Station (MS), thereby increasing system capacity and expanding coverage. The RS is different from a Radio Frequency (RF) RS currently used in a Code Division Multiple Access (CDMA) network in that a Decode & Forward (DF) method is used. In the DF method, a reconstructed signal is transmitted to the MS by analyzing a signal received from the BS. Optionally, direct scheduling may be performed to allocate resources.

When using a multi-hop relay network, an Automatic Repeat reQuest (ARQ) transmission method is necessary to ensure reliable data transmission. In general, the ARQ method is used between a source and a destination so that, when an ARQ block is lost during transmission, the lost ARQ block is retransmitted. In the multi-hop relay network, the ARQ block may be transmitted to an RS in addition to the source and the destination. In this case, the ARQ transmission method may be modified to achieve effective data transmission.

The following three issues must be taken into account when the ARQ method is used in the multi-hop relay network. First, throughput has to be considered. Hops from a source to a destination have different channel status. Further, a resource allocation amount for each hop varies depending on various factors. For example, if ten ARQ blocks, on average, can be transmitted for each frame between a BS and an RS while two ARQ blocks, on average, can be transmitted between the RS and an MS, transmission capacity of each hop becomes significantly different. In addition, a channel status and a resource allocation amount continuously change over time. When a situation changes after a predetermined time elapses, transmission capacity between the BS and the RS may change to one ARQ block, and transmission capacity between the RS and the MS may change to eight ARQ blocks. Due to time variability depending on a situation of each hop, high throughput can be obtained by using an adaptive ARQ method. Second, Media Access Control (MAC) efficiency has to be considered. The MAC efficiency indicates how much additional control information needs to be transmitted. In other words, an issue of how frequently an Acknowledgement (ACK) message will be transmitted is a general standard that is used for indicating ARQ efficiency. Third, handover has to be considered. In a multi-hop scenario, unlike a cellular network, an inter-RS handover occurs more frequently than an inter-BS handover. Since a BS or a MS is either a source or a destination of ARQ, the occurrence of the inter-RS handover represents changes in a path through which an ARQ block is transmitted. Even in this situation, the ARQ method needs to be performed without errors in the multi-hop relay network.

Wireless World Initiative New Radio (WINNER) is a part of an Information Society Technology (IST) project. As for the ARQ method for the multi-hop relay network, WINNER proposes an End-to-End (E2E) ARQ method, a hop-by-hop ARQ method, and a relay ARQ method.

In the E2E ARQ method, the conventional ARQ method is applied to a multi-hop relay network without alteration. In this method, nodes corresponding to an RS do not perform ARQ-related operations but perform only an operation for continuously transmitting a received packet to a next node. Therefore, in the E2E ARQ method, since the ARQ operation is performed only between the BS and the MS, the same operation as the conventional cellular network is performed.

Since the E2E ARQ method is used between the source and the destination, a situation where a specific hop has a poor channel status or a low resource allocation amount cannot be taken into consideration. Thus, throughput decreases over the entire section. In addition, even if an error occurs in one hop, an erroneous packet has to be retransmitted for all hops from the source to the destination. Thus, unnecessary retransmission may be frequently performed. Consequently, when the E2E ARQ method is used in the multi-hop relay network, there is a serious disadvantage in terms of throughput.

According to the hop-by-hop ARQ method, ARQ independently operates between hops in the multi-hop relay network. For example, when a BS and a MS are connected via one RS, the hop-by-hop ARQ method is performed such that retransmission is made within each hop by independently performing ARQ between the BS and the RS or between the RS and the MS. In addition, when the BS and the MS are connected via two or more RSs, retransmission is made by performing ARQ between the RSs as well. As such, since an ARQ window is independently managed for each hop, the hop-by-hop ARQ method has an advantage in that characteristics of each hop can be properly accounted for.

With the hop-by-hop ARQ method, throughput can be enhanced by using channel characteristics of each hop. In addition, since retransmission is independently performed for each hop, unnecessary retransmission is not performed as in the case of the E2E ARQ method. However, the following problems may occur when a handover is performed between an MS and an RS while communication is achieved by using this ARQ method. For example, among ARQ blocks 1 to 7 to be transmitted from a BS to an MS, assume that the ARQ blocks 1 and 2 are successfully transmitted to the MS via an RS, the ARQ blocks 3 and 4 are successfully transmitted to the RS but not yet to the MS, and the ARQ blocks 5 to 7 are not yet successfully transmitted to the RS. In this case, the BS discards the ARQ blocks 3 and 4, which have been successfully transmitted to the RS, from a queue of the BS. If the MS performs a handover to another RS in this situation, the ARQ blocks 3 and 4 are lost. In order to avoid such loss, forwarding is necessary in which the RS that has successfully received the ARQ blocks 3 and 4 transmits the ARQ blocks 3 and 4 to the BS, and upon receiving the ARQ blocks 3 and 4, the BS transmits the ARQ blocks 3 and 4 to an RS to which the MS just performed a handover. However, forwarding performed through a wireless section not only causes a waste of resources but also produces significant overhead since a reception state of the MS has to be fed back to the BS.

Finally, in the relay ARQ method, an RS directly performs data retransmission when an ARQ block transmitted by a source is successfully received but does not reach a destination. In this case, the RS transmits a Relay ACK (RACK) to the source upon successfully receiving the ARQ block, and thus the ARQ block transmitted by the source is prevented from being retransmitted. Then, the RS directly retransmits data to the destination. An overall ARQ operation of the relay ARQ method is based on the E2E ARQ method. However, when an error occurs, a hop behind the RS recognizes the occurrence of the error and then reports the error to the RS. Therefore, unnecessary retransmission between the source and the RS is avoided, thereby increasing transmission efficiency and throughput. However, since the relay ARQ method is basically based on the E2E ARQ method, the E2E ARQ method has a disadvantage in terms of throughput. In addition, the relay ARQ method has a problem in that, the number of ACK bits increases to 2 bits and an ACK message has to be modified when there is a need for the RS to feed back RACK to the source to report that the error has occurred in the hop behind the RS.

Accordingly, there is a need for an effective ARQ method that can be applied to the multi-hop relay network.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for performing effective Automatic Repeat reQuest (ARQ) in a multi-hop relay system.

Another aspect of the present invention is to provide an apparatus and method for performing ARQ in which ARQ is performed independently for each of the hops by using a hop-by-hop ARQ method in an uplink and downlink scenario of a multi-hop relay system, and an End-to-End (E2E) ARQ method is additionally used when a Mobile Station (MS) enters a handover region in the downlink scenario.

Another aspect of the present invention is to provide an apparatus and method in which the reception of data to be transmitted is suspended when a buffer overflow occurs for the data to be transmitted in a Relay Station (RS) of a multi-hop relay system.

According to an aspect of the present invention, an ARQ method in a Base Station (BS) of a multi-hop relay system is provided. The method includes the steps of determining whether a Mobile Station (MS) enters a handover region; if it is determined that the MS enters the handover region, transmitting an E2E-ARQ-Request message, which provides a notification that an End-to-End (E2E) ARQ method has begun to be used, to at least one of a Relay Station (RS) and the MS, transmitting to the RS an ARQ block to be transmitted to the MS, and storing the ARQ block in a queue; and if an Acknowledgement (ACK) for the ARQ block is received from the RS and if an E2E ACK which provides a notification that the MS has received the ARQ block is received from the at least one of the RS and the MS, discarding the ARQ block from the queue.

According to another aspect of the present invention, an ARQ method in an RS of a multi-hop relay system is provided. The method includes the steps of receiving from a Base Station (BS) an E2E-ARQ-Request message which provides a notification that an End-to-End (E2E) ARQ method has begun; if an ARQ block to be transmitted to a Mobile Station (MS) is received from the BS, transmitting the ARQ block to the MS and transmitting an Acknowledgement (ACK) for the ARQ block to the BS; and if the ACK is received from the MS, generating an E2E ACK which provides a notification that the MS has received the ARQ block and transmitting the E2E ACK to the BS.

According to another aspect of the present invention, an ARQ method in an MS of a multi-hop relay system is provided. The method includes the steps of receiving from a Base Station (BS) an E2E-ARQ-Request message which provides a notification that an End-to-End (E2E) ARQ method has begun to be used; if an ARQ block is received from a Relay Station (RS), transmitting an Acknowledgement (ACK) for the ARQ block to the RS, generating an E2E ACK which provides a notification that the ARQ block has been received, and transmitting the E2E ACK to the BS.

According to another aspect of the present invention, an ARQ apparatus of a multi-hop relay system is provided. The apparatus includes a Base Station (BS) for determining whether a Mobile Station (MS) enters a handover region and, if the MS enters the handover region, for transmitting to a Relay Station (RS) an E2E-ARQ-Request message which provides a notification that an End-to-End (E2E) ARQ method has begun to be used, together with an ARQ block to be transmitted to the MS, then for storing the ARQ block in a queue, and thereafter, if both an Acknowledgement (ACK) for the ARQ block and an E2E ACK which provides a notification that the MS has received the ARQ block are received from the RS, for discarding the ARQ block from the queue; and the RS for transmitting the ARQ block when both the E2E-ARQ-Reuqest message and the ARQ block to be transmitted to the MS are received from the BS, then for transmitting the ACK for the ARQ block to the BS, and then, upon receiving the ACK from the MS, for generating and transmitting the E2E ACK.

According to another aspect of the present invention, an ARQ apparatus of a multi-hop relay system is provided. The apparatus includes a Base Station (BS) for determining whether a Mobile Station (MS) enters a handover region and, if the MS enters the handover region, transmits to the MS an E2E-ARQ-Request message which provides a notification that an End-to-End (E2E) ARQ method has begun to be used, then for transmitting to a Relay Station (RS) an ARQ block to be transmitted to the MS, for storing the ARQ block in a queue, and thereafter, if an Acknowledgement (ACK) for the ARQ block is received from the RS and an E2E ACK which provides a notification that the MS has received the ARQ block is received from the MS, for discarding the ARQ block from the queue; the RS for transmitting the ARQ block to the MS and for transmitting the ACK for the ARQ block to the BS, if the ARQ block to be transmitted to the MS is received from the BS; and the MS for transmitting the ACK for the ARQ block to the RS, for generating the E2E ACK, and for transmitting the E2E ACK to the BS, if the E2E-ARQ-Request message is received from the BS and the ARQ block is received from the RS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a configuration of a multi-hop relay system according to an exemplary embodiment of the present invention;

FIGS. 2A and 2B illustrate signal flows of an Automatic Repeat reQuest (ARQ) operation in a multi-hop relay system according to an exemplary embodiment of the present invention;

FIG. 3 illustrates a signal flow of a downlink ARQ operation performed within a handover region in a multi-hop relay system according to an exemplary embodiment of the present invention;

FIG. 4 illustrates a signal flow of a downlink ARQ operation performed within a handover region in a multi-hop relay system according to an exemplary embodiment of the present invention;

FIG. 5 is a flowchart illustrating a process of performing a downlink ARQ operation performed within a handover region in a Base Station (BS) of a multi-hop relay system according to an exemplary embodiment of the present invention;

FIG. 6 is a flowchart illustrating a process of performing a downlink ARQ operation performed within a handover region in a Relay Station (RS) of a multi-hop relay system according to an exemplary embodiment of the present invention;

FIG. 7 is a flowchart illustrating a process of performing a downlink ARQ operation performed within a handover region in a Mobile Station (MS) of a multi-hop relay system according to an exemplary embodiment of the present invention;

FIG. 8 illustrates a signal flow of a buffer overflow that occurs in an RS of a multi-hop relay station according to an exemplary embodiment of the present invention;

FIG. 9 illustrates a signal flow of a hold request operation when a buffer overflow occurs in an RS of a multi-hop relay system according to an exemplary embodiment of the present invention;

FIG. 10 is a flowchart illustrating a process of a hold request operation when a buffer overflow occurs in an RS of a multi-hop relay system according to an exemplary embodiment of the present invention;

FIG. 11 is a flowchart illustrating a process in which data transmission is suspended when a buffer overflow of an RS occurs in a BS of a multi-hop relay system according to an exemplary embodiment of the present invention;

FIG. 12 is a graph for comparing throughput of a conventional ARQ method with throughput of an ARQ method proposed in an exemplary embodiment of the present invention; and

FIG. 13 is a graph for comparing Media Access Control (MAC) efficiency of a conventional ARQ method with respect to the ARQ method proposed in an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, an apparatus and method for performing effective Automatic Repeat reQuest (ARQ) in a multi-hop relay system of exemplary embodiments of the present invention will be described.

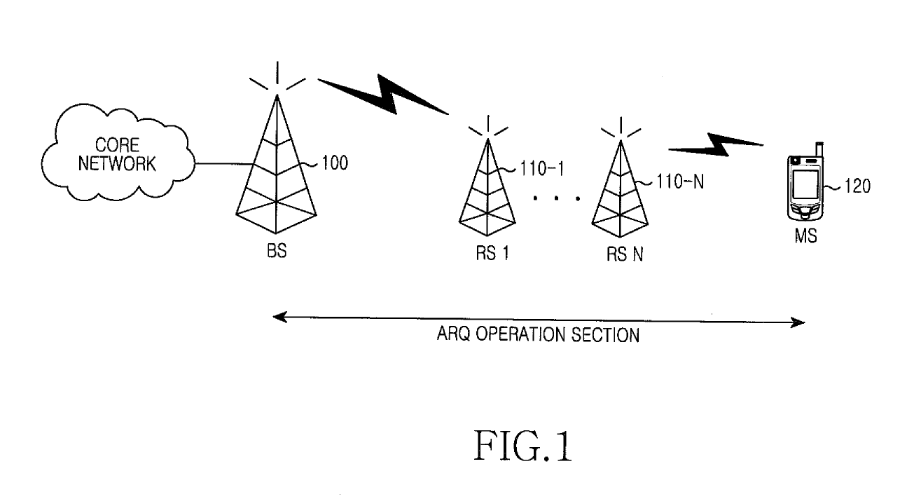

FIG. 1 illustrates a configuration of a multi-hop relay system according to an exemplary embodiment of the present invention.

Referring to FIG. 1, an ARQ method proposed in an exemplary embodiment of the present invention operates in a multi-hop relay network in which Relay Stations (RSs) 110-1, . . . , 110-N are used to connect a Base Station (BS) 100 and a Mobile Station (MS) 120. The BS 100 and the MS 120 are located at both ends of an ARQ operation section. One or more RSs 110-1, . . . , 110-N may be located between the BS 100 and the MS 120 so as to perform a function for delivering ARQ blocks. The RSs 110-1, . . . , 110-N may perform scheduling to determine whether to transmit the ARQ blocks. Since queues are provided to store the ARQ blocks, the RSs 110-1, . . . , 110-N can deliver the ARQ blocks to a next node without the aid of the BS if retransmission is required. Further, the RSs 110-1, . . . , 110-N use sequence numbers of the ARQ blocks received from a previous node and deliver the sequence numbers without alternation to a next node. That is, the ARQ blocks are delivered without being reconstructed, for example, being divided, combined, and so on. As a result, complexity of the implementation can be reduced.

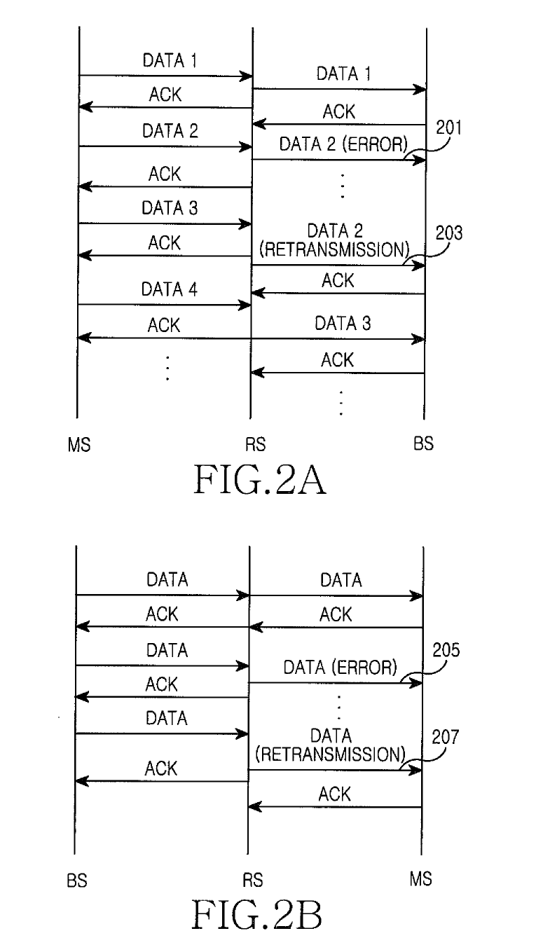

FIGS. 2A and 2B illustrates signal flows of an ARQ operation in a multi-hop relay system according to an exemplary embodiment of the present invention.

Hereinafter, a path from an MS to a BS is defined as an uplink, and a path from the BS to the MS is defined as a downlink. In an uplink scenario of the multi-hop relay system, an ARQ operation according to an exemplary embodiment of the present invention uses a conventional hop-by-hop ARQ method. That is, ARQ is independently performed between hops, and retransmission is performed within each hop. If the hop-by-hop ARQ method is used in the uplink scenario, the conventional problem of packet loss due to a handover is overcome. Thus, considering only throughput and Media Access Control (MAC) efficiency, without having to taking handover scenarios into account, the highest throughput can be obtained.

In a downlink scenario of the multi-hop relay system, an ARQ operation according to an exemplary embodiment of the present invention is classified into two cases: a case where an MS exists outside a handover region and a case where the MS exists inside the handover region. Herein, a handover represents an inter-RS handover performed between RSs existing within a coverage of the same BS. The MS can determine whether the MS exists within the handover region by using a pilot signal received from a different RS. Further, the MS may transmit the determination result to the BS so that the BS can determine whether the MS exists within the handover region. According to a type of system in use, the determination on whether the MS exists within the handover region may different. However, certain exemplary embodiments of the present invention may apply to all systems that can determine whether the MS exists within the handover region. In a general downlink scenario where the MS exists outside the handover region, the ARQ operation according to an exemplary embodiment of the present invention uses the conventional hop-by-hop ARQ method similar to the ARQ operation in the uplink scenario.

An ARQ operation in the uplink scenario will be first described with reference to FIG. 2A. A MS transmits data (i.e., ARQ blocks) to an RS, and then stores the ARQ blocks in a queue of the MS. When the RS successfully receives the ARQ blocks, the RS stores the ARQ blocks in a queue of the RS, delivers ACK to the MS, and transmits the ARQ blocks to a next node (i.e., BS). In this case, upon receiving the ACK from the RS, the MS discards the ARQ blocks from the queue of the MS, and properly moves a Transmission (TX) window of the MS. Thereafter, when the BS successfully receives the ARQ blocks from the RS, the BS delivers the ACK to the RS. Likewise, upon receiving the ACK from the BS, the RS discards the ARQ blocks from the queue of the RS, and properly moves a TX window of the RS. Herein, the TX window of the MS operates independently from the TX window of the RS. Further, the ACK is sent to only an immediately previous node and is not forwarded further.

Meanwhile, after transmitting a specific ARQ block, if the ACK for the ARQ block is not received before an ARQ timer has timed out, the MS (or RS) that has transmitted the ARQ block determines that an error has occurred in the transmission of the ARQ block, extracts the ARQ block from its queue, and retransmits the ARQ block. In this case, retransmission is performed for each hop. For example, when an error occurs when a specific block is transmitted from the RS to the BS (as indicated by 201 in the figure), the RS directly retransmits the ARQ block (as indicated by 203 in the figure). In this case, the MS operates irrespective of the error.

Now, an ARQ operation in a general downlink scenario will be described with reference to FIG. 2B. Similar to the ARQ operation in the uplink scenario, ARQ is independently performed for each hop, and ACK is delivered to an immediately previous node and is not forwarded any further. When an ARQ block has not been successfully transmitted from a previous node to a next node, the previous node extracts the ARQ block from its queue and then transmits the ARQ block to the next node. For example, when an error occurs when a specific block is transmitted from the RS to the MS (as indicated by 205 in the figure), the RS directly retransmits the ARQ block (as indicated by 207 in the figure). In this case, the BS operates irrespective of the error.

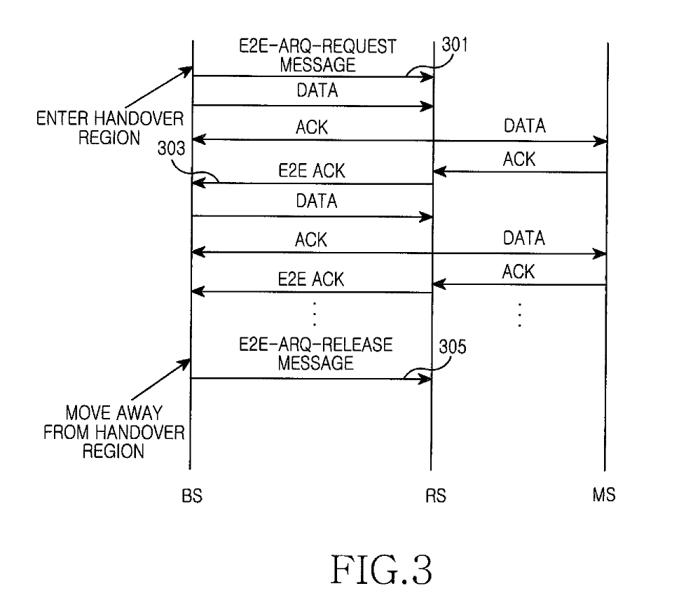

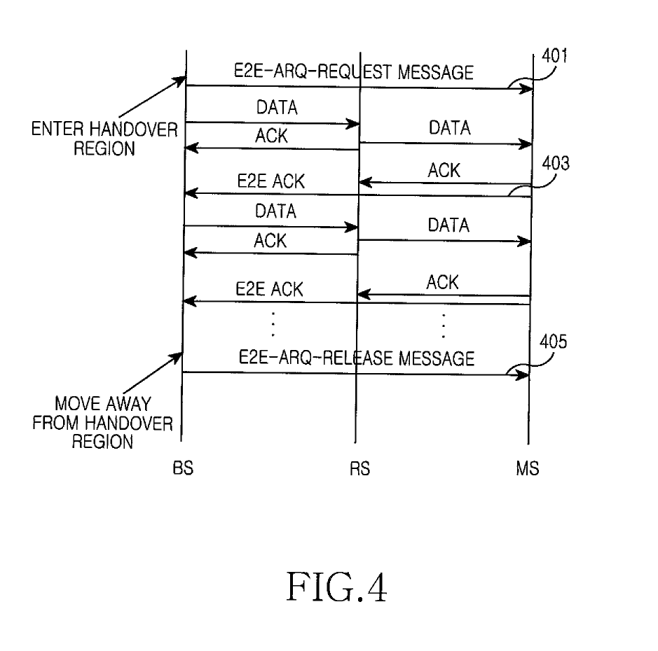

As such, in the general downlink scenario where the MS exists outside the handover region, the ARQ independently operates between hops by using the conventional hop-by-hop ARQ method, and retransmission is made within each hop. Meanwhile, according to another exemplary embodiment of the present invention, in a downlink scenario where the MS exists within the handover region, an E2E ARQ method may be additionally used together with the conventional hop-by-hop ARQ method. The E2E ARQ method may operate in two different ways according to which E2E ACK is generated and transmitted. In a method shown in FIG. 3, an immediately previous node (i.e., RS) of a destination (i.e., MS) generates the E2E ACK for the E2E ARQ and then transmits the E2E ACK to a BS. In a method shown in FIG. 4, a destination (i.e. MS) directly generates the E2E ACK for the E2E ARQ and then transmits the E2E ACK to a BS. In the following descriptions, explanation on the hop-by-hop ARQ method will be omitted, and only the additional E2E ARQ method will be explained.

FIG. 3 illustrates a signal flow of a downlink ARQ operation performed within a handover region in a multi-hop relay system according to an exemplary embodiment of the present invention.

Referring to FIG. 3, a BS transmits an E2E-ARQ-Request message 301 to an RS at approximately the moment when an MS enters a handover region.

Thereafter, the BS transmits, to the RS, data (i.e., ARQ blocks) to be transmitted to the MS. Upon successfully receiving the ARQ blocks, the RS transmits ACK for the ARQ blocks to the BS and transmits the ARQ blocks to the MS. Upon successfully receiving the ARQ blocks, the MS transmits ACK for the ARQ blocks to the RS, and after receiving the ACK, the RS determines whether E2E transmission is successful. Then, the RS directly generates an E2E ACK 303 for the ARQ blocks and then transmits the E2E ACK 303 to the BS. That is, the E2E-ARQ-Request message 301 is not delivered up to the MS but to the RS that is an immediately previous node of the MS. The E2E ARQ between the BS and the MS is maintained as long as the MS is located within the handover region.

E2E-related ARQ blocks are transmitted after the E2E-ARQ-Request message 301 is transmitted, and then the BS starts to buffer the E2E-related ARQ blocks in a queue. That is, even if the E2E ACK 303 is not successfully received after the ARQ blocks are successfully transmitted to a next node (i.e., BS), the BS stores the ARQ blocks in the queue instead of discarding the ARQ blocks. Thereafter, when receiving both the ACK and the E2E ACK, the BS recognizes that the ARQ blocks have been successfully transmitted and discards the ARQ blocks buffered in the queue. Then, the BS moves a window of the E2E ARQ. The BS may use a TX window to regulate an amount of blocks to be transmitted. In addition, the BS operates an ARQ timer for each block and thus E2E retransmission is carried out for an ARQ block whose timer has timed out before the E2E ACK was received. In this case, the BS has to retransmit the ARQ block which has already been successfully transmitted to the RS. According to the E2E ARQ operation, the BS can retransmit data even when the conventional handover problem occurs as described above. As a result, the MS can successfully receive all blocks.

When the MS moves to outside the handover region, the BS determines whether E2E ACK is received. Upon receiving the E2E ACK, the BS transmits an E2E-ARQ-Release message 305 to the RS. Then, the BS stops the E2E ARQ operation and discards all E2E-related ARQ blocks currently buffered in the queue. The RS also finishes an E2E ACK transmission process and returns to a previous normal condition in which only the hop-by-hop type ARQ is used.

FIG. 4 illustrates a signal flow of a downlink ARQ operation performed within a handover region in a multi-hop relay system according to an exemplary embodiment of the present invention.

Referring to FIG. 4, a BS transmits an E2E-ARQ-Request message 401 to an MS at approximately the moment when the MS enters a handover region.

Thereafter, the BS transmits, to the RS, data (i.e., ARQ blocks) to be transmitted to the MS. Upon successfully receiving the ARQ blocks, the RS transmits the ACK for the ARQ blocks to the BS and transmits the ARQ blocks to the MS. Upon successfully receiving the ARQ blocks, the MS transmits the ACK for the ARQ blocks to the RS. Then, the RS directly generates an E2E ACK 403 for the ARQ blocks and then transmits the E2E ACK 403 to the BS. In this case, upon receiving the ACK, the RS delivers the received ACK to the BS. Since the MS directly generates E2E ACK, the E2E-ARQ-Request message 401 has to be transmitted up to the MS. The E2E ARQ between the BS and the MS is maintained as long as the MS is located within the handover region. Although it has been described that the E2E-ARQ-Request message 401 and the E2E ACK 403 are directly transmitted and received between the BS and the MS, in certain an exemplary embodiments of the present invention these messages 401 and 403 may be relayed by the use of the RS.

E2E-related ARQ blocks are transmitted after the E2E-ARQ-Request message 401 is transmitted, and then the BS starts to buffer the E2E-related ARQ blocks in a queue. That is, even if the E2E ACK 403 is not successfully received after the ARQ blocks are successfully transmitted to a next node (i.e., BS), the BS stores the ARQ blocks in the queue instead of discarding the ARQ blocks. Thereafter, when receiving both the ACK and the E2E ACK, the BS recognizes that the ARQ blocks have been successfully transmitted and discards the ARQ blocks buffered in the queue. Then, the BS moves a window of the E2E ARQ. The BS may use a TX window to regulate an amount of blocks to be transmitted. In addition, the BS operates an ARQ timer for each block and thus E2E retransmission is carried out for an ARQ block whose timer has timed out before the E2E ACK was received. In this case, the BS has to retransmit the ARQ block which has already been successfully transmitted to the RS. According to the E2E ARQ operation, the BS can retransmit data even when the conventional handover problem occurs as described above. As a result, the MS can successfully receive all blocks

When the MS moves to outside the handover region, the BS determines whether the E2E ACK is received. Upon receiving the E2E ACK, the BS transmits an E2E-ARQ-Release message 405 to the MS. Then, the BS stops the E2E ARQ operation and discards all E2E-related ARQ blocks currently buffered in the queue. The MS also finishes an E2E ACK transmission process and returns to a previous normal condition in which only the hop-by-hop type ARQ is used.

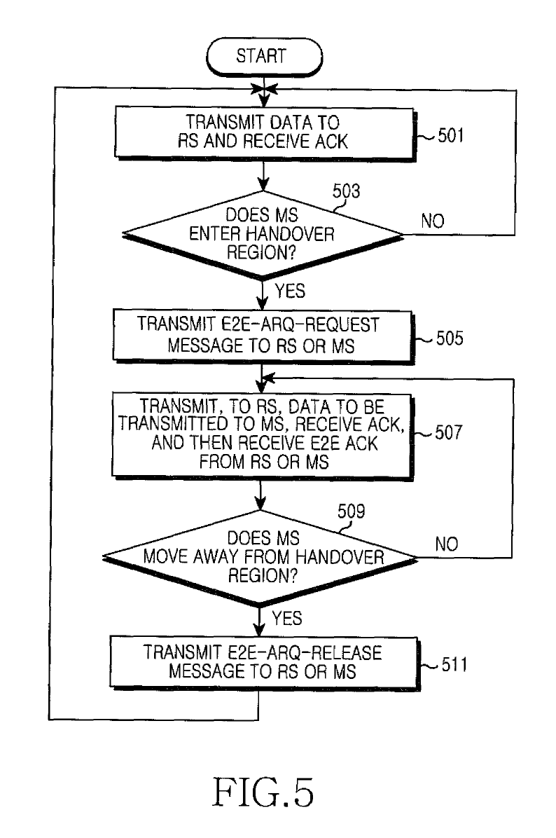

FIG. 5 is a flowchart illustrating a process of performing a downlink ARQ operation performed within a handover region in a BS of a multi-hop relay system according to an exemplary embodiment of the present invention.

Referring to FIG. 5, in step 501, the BS transmits, to an RS, data (i.e., ARQ blocks) to be transmitted to an MS, and receives the ACK for the ARQ blocks.

In step 503, the BS determines whether the MS enters a handover region. If it is not determined that the MS enters the handover region, returning back to step 501, the BS transmits the ARQ blocks to the RS and receives the ACK for the ARQ blocks from the RS. On the other hand, if it is determined that the MS enters the handover region, in step 505, the BS transmits an E2E-ARQ-Request message to the RS or the MS. The E2E-ARQ-Request message contains a sequence number of a specific ARQ block to which the E2E ARQ method is first used. In this case, the BS may receive an E2E-ARQ-Response message from the RS or the MS.

In step 507, the BS transmits the ARQ blocks, which are to be transmitted to the MS, to the RS and stores the ARQ blocks in a queue. In addition, the BS receives ACK for the ARQ blocks from the RS and receives E2E ACK, which provides a notification that the E2E transmission has been successfully carried out for the ARQ blocks, from the RS or the MS. In this case, the BS operates an ARQ timer for each block. If the E2E ACK is not received before the ARQ timer has timed out, the BS extracts the ARQ blocks from the queue and retransmits the ARQ blocks. On the other hand, if both the ACK and the E2E ACK are received before the ARQ timer has timed out, the BS discards the ARQ blocks buffered in the queue and then moves a window of E2E ARQ.

In step 509, the BS determines whether the MS moves outside the handover region. If it is not determined that the MS moves outside the handover region, the process returns back to step 507 and the BS repeats the subsequent steps until the MS moves outside the handover region. On the other hand, if it is determined that the MS moves outside the handover region, in step 511, the BS receives data until the E2E ACK is received and then transmits an E2E-ARQ-Release message to the RS or the MS. After stopping the E2E ARQ operation, the process returns back to step 501 and the BS repeats the subsequent steps. In other words, when returning back to a previous normal condition, the BS performs only a hop-by-hop type ARQ operation. In this case, the BS may discard all E2E-related ARQ blocks currently buffered in the queue and may receive an E2E-ARQ-Response message from the RS or the MS.

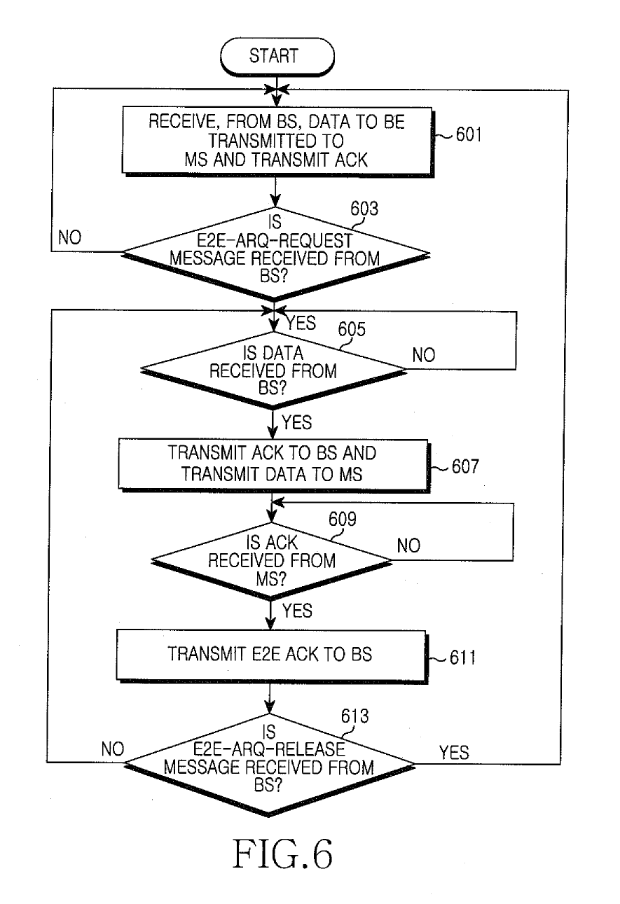

FIG. 6 is a flowchart illustrating a process of performing a downlink ARQ operation performed within a handover region in an RS of a multi-hop relay system according to an exemplary embodiment of the present invention.

Referring to FIG. 6, in step 601, an RS receives, from the BS, data (i.e., ARQ blocks) to be transmitted to an MS and transmits an ACK to the BS upon successfully receiving the ARQ blocks.

In step 603, the RS checks whether an E2E-ARQ-Request message is received from the BS. The E2E-ARQ-Request message contains a sequence number of a specific ARQ block to which the E2E ARQ method is first used. If the E2E-ARQ-Request message is not received, the process returns back to step 601 and the RS repeats the subsequent steps. On the other hand, if the E2E-ARQ-Request message is received, in step 605, the RS checks whether the ARQ blocks are received from the BS. Herein, upon receiving the E2E-ARQ-Request message, the RS may transmit to the BS an E2E-ARQ-Response message for informing that the E2E-ARQ-Request message has been successfully received.

Upon receiving the ARQ blocks from the BS, in step 607, if the ARQ block has been successfully received, the RS transmits the ACK for the ARQ blocks to the BS and then transmits the ARQ blocks to the MS. In step 609, the RS checks whether the ACK is received from the MS. Upon receiving the ACK, in step 611, the RS generates an E2E ACK which provides a notification that E2E transmission has been successfully carried out for the ARQ blocks and then transmits the E2E ACK to the BS.

In step 613, the RS checks whether an E2E-ARQ-Release message is received from the BS. If the E2E-ARQ-Release message is received, the process returns back to step 601 and the RS repeats the subsequent steps. If the E2E-ARQ-Relesase message is not received, the process returns back to step 605 and the RS repeats subsequent steps until the E2E-ARQ-Release message is received. When the E2E-ARQ-Relesase message is received, the RS may transmit an E2E-ARQ-Response message to the BS.

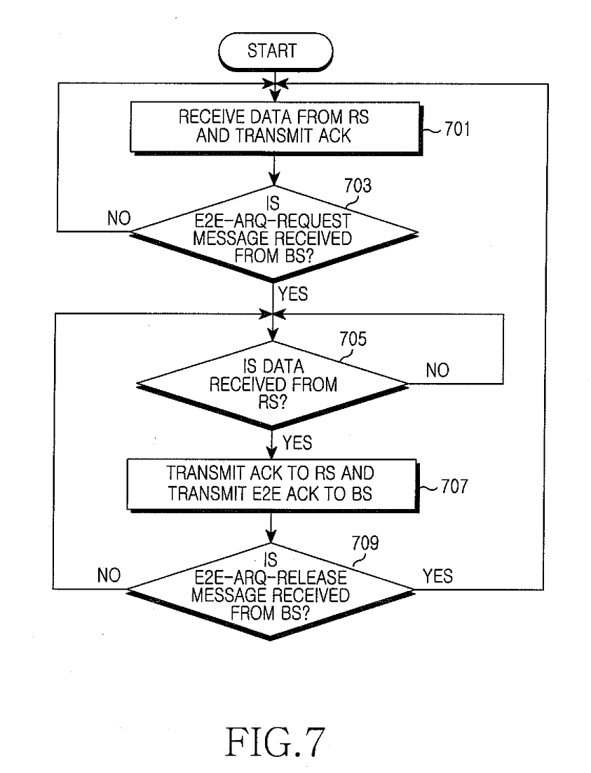

FIG. 7 is a flowchart illustrating a process of performing a downlink ARQ operation performed within a handover region in an MS of a multi-hop relay system according to an exemplary embodiment of the present invention.

Referring to FIG. 7, in step 701, the MS receives data (i.e., ARQ blocks) from an RS and transmits an ACK for the ARQ blocks successfully received from the RS.

In step 703, the MS checks whether an E2E-ARQ-Request message is received from the BS. The E2E-ARQ-Request message contains a sequence number of a specific ARQ block to which the E2E ARQ method is first used. If the E2E-ARQ-Request message is not received, the process returns back to step 701 and the MS repeats subsequent steps. On the other hand, if the E2E-ARQ-Request message is received, in step 705, the MS checks whether the ARQ blocks are received from the RS. When the E2E-ARQ-Request message is received, the MS may transmit to the BS an E2E-ARQ-Response message for informing that the E2E-ARQ-Request message has been successfully received.

Upon receiving the ARQ blocks from the RS, in step 707, if the ARQ block has been successfully received, the MS transmits an ACK for the ARQ blocks to the RS, generates E2E ACK which provides a notification that E2E transmission has been successfully carried out for the ARQ blocks, and transmits the E2E ACK to the BS.

In step 709, the MS checks whether an E2E-ARQ-Release message is received from the BS. If the E2E-ARQ-Release message is received, the process returns back to step 701 and the MS repeats the subsequent steps. If the E2E-ARQ-Relesase message is not received, the process returns back to step 705 and the MS repeats the subsequent steps until the E2E-ARQ-Release message is received. When the E2E-ARQ-Release message is received, the MS may transmit an E2E-ARQ-Response message to the BS.

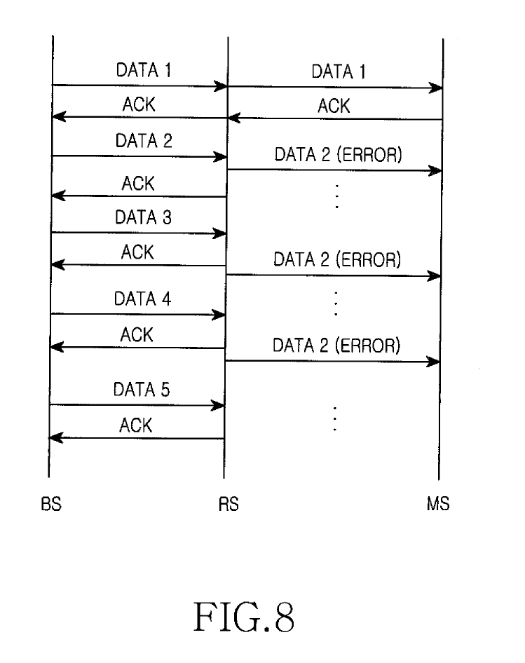

Meanwhile, an excessive amount of ARQ blocks may be stacked in a queue of an RS when ARQ is independently performed for each hop according to an exemplary embodiment of the present invention. For example, as shown in FIG. 8, if a channel status between a BS and an RS is good and a channel status between the RS and an MS is poor, and although the BS continuously successfully transmits ARQ blocks to the RS, the RS cannot transmit the ARQ blocks to the MS. As a result, a buffer overflow may occur in which numerous blocks are stacked in the queue of the RS. In order to address this problem, certain exemplary embodiments of the present invention propose a new instruction called ‘hold request’. According to the hold request, transmission of ARQ blocks is suspended when a queue level of the RS is greater than or equal to a preset level. In the following descriptions, an example is described of a buffer overflow occurs in a block which is received from a BS in a downlink scenario. However, certain exemplary embodiments of the present invention may also apply to a buffer overflow occurring in a block received from an MS in an uplink scenario.

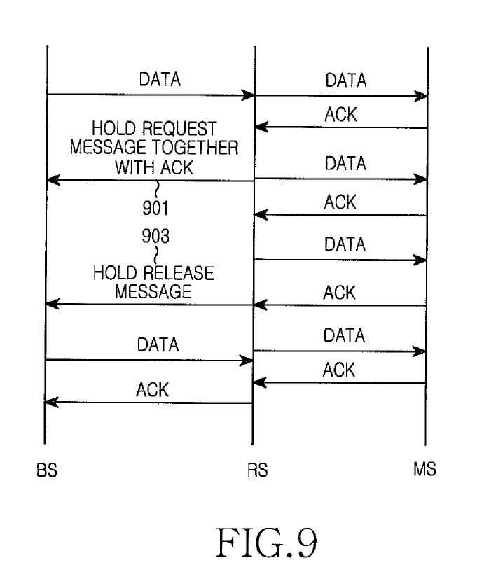

FIG. 9 illustrates a signal flow of a hold request operation when a buffer overflow occurs in an RS of a multi-hop relay system according to an exemplary embodiment of the present invention.

Referring to FIG. 9, when the number of blocks stacked in a queue of the RS increases to be greater than or equal to a preset threshold, the RS delivers a hold request message 901 together with ACK to a BS (i.e., previous node) so that the BS temporarily suspends data transmission. In the mean time, the RS continuously transmits the blocks to an MS (i.e., next node), and, when a level of the queue decreases to be below a threshold, transmits a hold release message 903 to the BS and thus resumes the suspended transmission. The hold request message and the hold release message deliver simple ON/OFF information only. When delivered, the hold request message may be included in an ACK message. However, the hold release message has to be delivered separately from the ACK message.

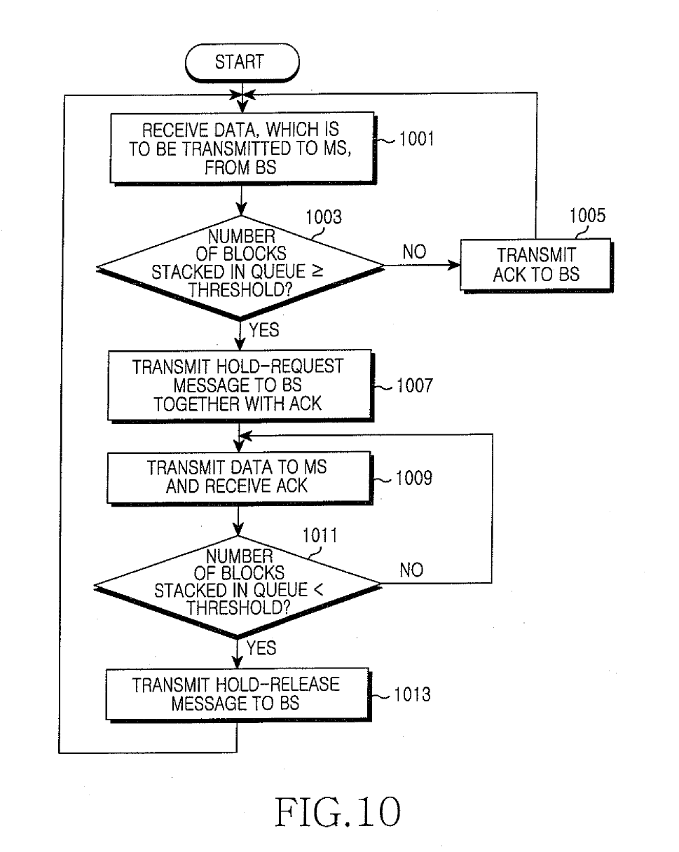

FIG. 10 is a flowchart illustrating a process of a hold request operation when a buffer overflow occurs in an RS of a multi-hop relay system according to an exemplary embodiment of the present invention.

Referring to FIG. 10, in step 1001, the RS checks whether data (i.e., ARQ blocks) to be transmitted to an MS is received from a BS. Upon receiving the ARQ blocks, in step 1003, the RS checks whether the number of blocks stacked in a queue is greater than or equal to a preset threshold. If the number of blocks stacked in the queue is less than the preset threshold, in step 1005, the RS transmits, to the BS, an ACK for the ARQ blocks successfully received. The process then returns back to step 1001 and repeats the subsequent steps. Although not shown, in this case, after storing the ARQ blocks successfully received from the BS in the queue, the RS transmits the ARQ block to the MS, and upon receiving the ACK for the ARQ blocks successfully received from the MS, the RS discards the ARQ blocks from the queue.

If the number of blocks stacked in the queue is greater than or equal to the preset threshold, in step 1007, the RS transmits, to the BS, a hold request message together with an ACK for the ARQ block successfully received, so that the BS temporarily suspends data transmission. Thereafter, in step 1009, the RS stores the ARQ blocks successfully received from the BS in the queue and then transmits the ARQ blocks to the MS. When the ACK is received from the MS for the ARQ blocks successfully received, the RS discards the specific blocks from the queue.

In step 1011, the RS checks whether the number of blocks stacked in the queue is less than the threshold. If the number of blocks stacked in the queue is still greater than or equal to the threshold, the process returns back to step 1009 and the RS transmits the ARQ blocks to the MS until the number of blocks stacked in the queue becomes less than the threshold, and then receives the ACK for the successfully received blocks from the MS. On the other hand, if the number of blocks stacked in the queue is less than the threshold, in step 1013, the RS transmits a hold release message to the BS and thus resumes the suspended transmission. Then, the process returns back to step 1001 and the RS repeats subsequent steps.

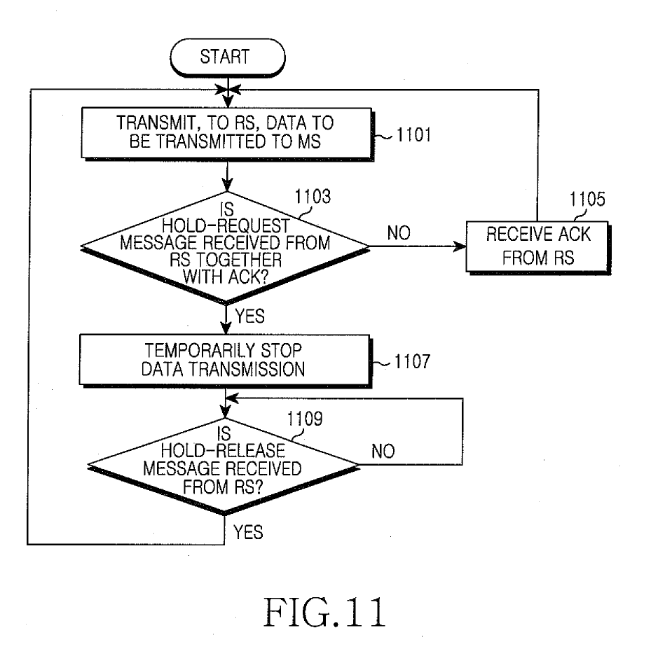

FIG. 11 is a flowchart illustrating a process in which data transmission is suspended when a buffer overflow of an RS occurs in a BS of a multi-hop relay system according to an exemplary embodiment of the present invention.

Referring to FIG. 11, in step 1101, the BS transmits, to the RS, data (i.e., ARQ blocks) to be transmitted to an MS.

In step 1103, the BS checks whether a hold request message is received from the RS together with an ACK for the successfully received blocks. Upon receiving the hold request message together with the ACK, in step 1107, the BS temporarily stops transmission of the data to the RS. Then, proceeding to step 1109, the BS checks whether a hold release message is received from the RS. Upon receiving the hold release message, the process returns back to step 1101 and the BS resumes transmission of the data to the RS and repeats the subsequent steps.

On the other hand, if the hold request message is not received together with the ACK in step 1103, the BS receives the ACK for the successfully received blocks from the RS. The process then returns back to step 1101 and the subsequent steps are performed.

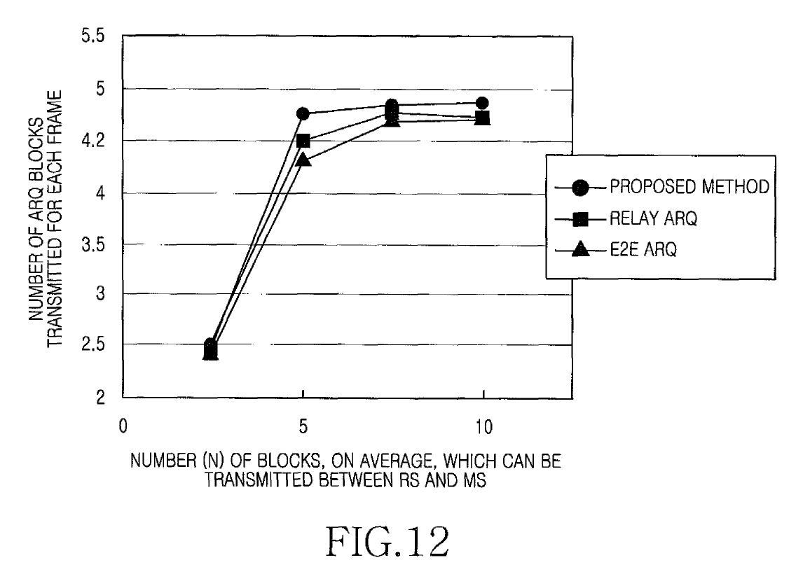

FIG. 12 is a graph comparing the throughput of a conventional ARQ method with the throughput of an ARQ method proposed in an exemplary embodiment of the present invention. The group shows a throughput obtained in a BS-RS-MS downlink scenario by comparing the number of ARQ blocks transmitted for each frame of one MS with respect to the two ARQ methods.

Referring to FIG. 12, for the number of ARQ blocks that can be transmitted, integer values in the range of 0 to 10 are uniformly generated between the BS and the RS. In addition, integer values in the range of 0 to 2×n are uniformly generated between the RS and the MS. If it is assumed that a data transmission error occurs in the ARQ blocks with a probability of 0.001, the highest throughput can be obtained according to the ARQ method proposed in the exemplary embodiments of the present invention. Herein, n denotes the number of ARQ blocks, on average, which can be transmitted between the RS and the MS.

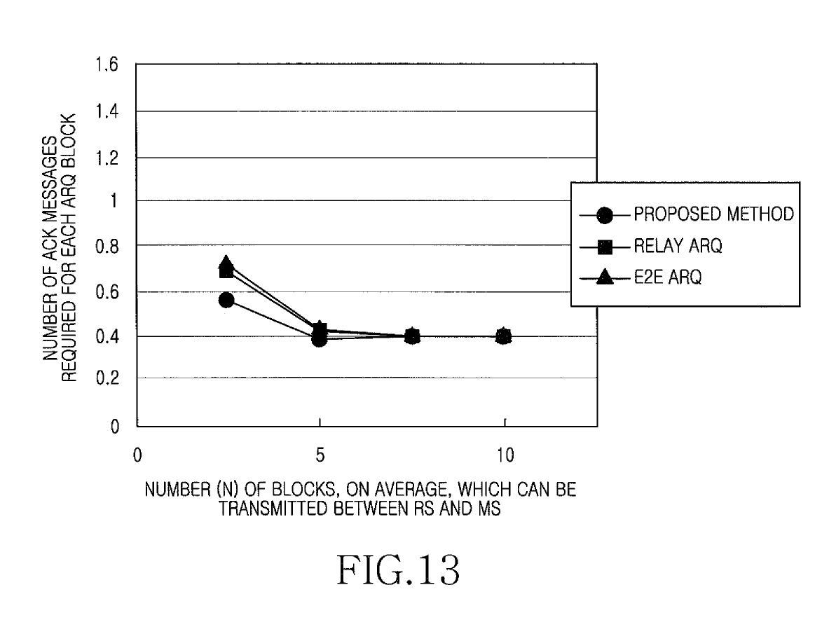

FIG. 13 is a graph for comparing MAC efficiency of a conventional ARQ method with respect to the ARQ method proposed in an exemplary embodiment of the present invention. The group shows how many ACK messages are required to transmit one ARQ block. The smaller the number of ACK messages required to transmit one ARQ block, the better the MAC efficiency.

Referring to FIG. 13, the highest MAC efficiency can be obtained when the ARQ method proposed in an exemplary embodiment of the present invention is used.

According to exemplary embodiments of the present invention, an apparatus and method for performing ARQ is provided in which ARQ is performed independently for each of the hops by using a hop-by-hop ARQ method in an uplink and downlink scenario of a multi-hop relay system, and an E2E ARQ method is additionally used when an MS enters a handover region in the downlink scenario. Therefore, throughput can be enhanced by properly using the characteristics of each hop in a multi-hop environment, and MAC efficiency can be improved by minimizing the number of ACK messages to be transmitted. Further, there is an advantage in that errors may occur even if an MS performs a handover, and a problem of frequent downlink packet loss can be solved which may occur when a handover between the MS and an RS is performed, thereby enabling an effective ARQ service. Finally, when the number of blocks stacked in a queue of the RS is greater than or equal to a preset threshold, reception of data to be transmitted is suspended. Therefore, the occurrence of a buffer overflow can be avoided in which numerous blocks are stacked in the queue of the RS.

Certain aspects of the present invention can also be embodied as computer readable code on a computer readable recording medium. A computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. An Automatic Repeat reQuest (ARQ) method in a Base Station (BS) of a multi-hop relay system, the method comprising:
determining whether a Mobile Station (MS) enters a handover region;
if it is determined that the MS enters the handover region, transmitting an E2E-ARQ-Request message, which provides a notification that an End-to-End (E2E) ARQ method has begun to be used, to at least one of a Relay Station (RS) and the MS, transmitting to the RS an ARQ block to be transmitted to the MS, and storing the ARQ block in a queue; and
if an Acknowledgement (ACK) for the ARQ block is received from the RS and if an E2E ACK which provides a notification that the MS has received the ARQ block is received from the at least one of the RS and the MS, discarding the ARQ block from the queue.

2. The method of claim 1, further comprising:
if it is not determined that the MS enters the handover region, transmitting to the RS the ARQ block to be transmitted to the MS and storing the ARQ block in the queue; and
if the ACK for the ARQ block is received from the RS, discarding the ARQ block from the queue.

3. The method of claim 1, further comprising:
determining whether the MS leaves the handover region; and
if it is determined that the MS leaves the handover region, after completing the reception of the E2E ACK for the previously transmitted ARQ block, discarding the ACK block stored in the queue, transmitting an E2E-ARQ-Release message to at least one of the RS and the MS, and performing a process that is the same process as a process performed before the MS enters the handover region.

4. The method of claim 1, wherein the E2E-ARQ-Request message contains a sequence number of the ARQ block to which the E2E ARQ method is first used.

5. The method of claim 1, further comprising, if the E2E ACK for the ARQ block is not received from at least one of the RS and the MS until an ARQ timer for the ARQ block has timed out, extracting the ARQ block from the queue and retransmitting the ARQ block.

6. The method of claim 1, further comprising, upon receiving from the RS a hold request message, which provides a notification that ARQ block transmission has to be temporarily stopped, together with the ACK for the ARQ block, stopping the transmission of the ARQ block.

7. The method of claim 6, further comprising, upon receiving from the RS a hold release message which provides a notification that transmission has to be resumed, resuming the transmission of the ARQ block.

8. An Automatic Repeat reQuest (ARQ) method in a Relay Station (RS) of a multi-hop relay system, the method comprising:
receiving from a Base Station (BS) an E2E-ARQ-Request message which provides a notification that an End-to-End (E2E) ARQ method has begun;
if an ARQ block to be transmitted to a Mobile Station (MS) is received from the BS, transmitting the ARQ block to the MS and transmitting an Acknowledgement (ACK) for the ARQ block to the BS; and
if the ACK is received from the MS, generating an E2E ACK which provides a notification that the MS has received the ARQ block and transmitting the E2E ACK to the BS.

9. The method of claim 8, further comprising, if the E2E-ARQ-Request message is not received, receiving from the BS the ARQ block to be transmitted to the MS, transmitting the received ARQ block to the MS, and transmitting the ACK for the ARQ block to the BS.

10. The method of claim 8, further comprising:
checking whether an E2E-ARQ-Release message is received from the BS; and
if the E2E-ARQ-Release message is received, performing a process that is the same process as a process performed before the E2E-ARQ-Request message is received.

11. The method of claim 8, wherein the E2E-ARQ-Request message contains a sequence number of the ARQ block to which the E2E ARQ method is first used.

12. The method of claim 8, further comprising:
if ARQ blocks are received from a source to a destination, checking whether the number of ARQ blocks stored in a queue is greater than or equal to a preset threshold; and
if the number of ARQ blocks is greater than or equal to the preset threshold, transmitting a hold request message, which provides a notification that ARQ block transmission has to be temporarily stopped, to the source together with an ACK message for the ARQ blocks.

13. The method of claim 12, further comprising transmitting to the destination the ARQ blocks stored in the queue until the number of ARQ blocks becomes less than the preset threshold, and, if the number of ARQ blocks becomes less than the preset threshold, transmitting a hold release message, which provides a notification that transmission has to be resumed, to the source.

14. An Automatic Repeat reQuest (ARQ) method in a Mobile Station (MS) of a multi-hop relay system, the method comprising:
receiving from a Base Station (BS) an E2E-ARQ-Request message which provides a notification that an End-to-End (E2E) ARQ method has begun to be used;
if an ARQ block is received from a Relay Station (RS), transmitting an Acknowledgement (ACK) for the ARQ block to the RS, generating an E2E ACK which provides a notification that the ARQ block has been received, and transmitting the E2E ACK to the BS.

15. The method of claim 14, further comprising, if the E2E-ARQ-Request message is not received, receiving the ARQ block from the RS and transmitting the ACK for the received ARQ block to the RS.

16. The method of claim 14, further comprising:
checking whether an E2E-ARQ-Release message is received from the BS; and
if the E2E-ARQ-Release message is received, performing a process that is the same process as a process performed before the E2E-ARQ-Request message is received.

17. The method of claim 14, wherein the E2E-ARQ-Request message contains a sequence number of a ARQ block to which the E2E ARQ method is first used.

18. An Automatic Repeat reQuest (ARQ) apparatus of a multi-hop relay system, the apparatus comprising:
a Base Station (BS) for determining whether a Mobile Station (MS) enters a handover region and, if the MS enters the handover region, for transmitting to a Relay Station (RS) an E2E-ARQ-Request message which provides a notification that an End-to-End (E2E) ARQ method has begun to be used, together with an ARQ block to be transmitted to the MS, then for storing the ARQ block in a queue, and thereafter, if both an Acknowledgement (ACK) for the ARQ block and an E2E ACK which provides a notification that the MS has received the ARQ block are received from the RS, for discarding the ARQ block from the queue; and
the RS for transmitting the ARQ block when both the E2E-ARQ-Reuqest message and the ARQ block to be transmitted to the MS are received from the BS, then for transmitting the ACK for the ARQ block to the BS, and then, upon receiving the ACK from the MS, for generating and transmitting the E2E ACK.

19. The apparatus of claim 18, wherein, if it is not determined that the MS enters the handover region, the BS transmits to the RS the ARQ block to be transmitted to the MS and stores the ARQ block in the queue, and if the ACK for the ARQ block is received from the RS, the BS discards the ARQ block from the queue.

20. The apparatus of claim 18, wherein the BS determines whether the MS leaves the handover region, and, if it is determined that the MS leaves the handover region, the BS completes the reception of the E2E ACK for the previously transmitted ARQ block, discards the ACK block stored in the queue, transmits an E2E-ARQ-Release message to at least one of the RS and the MS, and performs a process that is the same process as a process performed before the MS enters the handover region.

21. The apparatus of claim 18, wherein, if the E2E-ARQ-Request message is not received, the RS receives from the BS the ARQ block to be transmitted to the MS, transmits the received ARQ block to the MS, and transmits the ACK for the ARQ block to the BS.

22. The apparatus of claim 18, wherein the RS checks whether an E2E-ARQ-Release message is received from the BS, and, if the E2E-ARQ-Release message is received, performs the same process as that performed before the E2E-ARQ-Request message is received.

23. An Automatic Repeat reQuest (ARQ) apparatus of a multi-hop relay system, the apparatus comprising:
a Base Station (BS) for determining whether a Mobile Station (MS) enters a handover region and, if the MS enters the handover region, transmits to the MS an E2E-ARQ-Request message which provides a notification that an End-to-End (E2E) ARQ method has begun to be used, then for transmitting to a Relay Station (RS) an ARQ block to be transmitted to the MS, for storing the ARQ block in a queue, and thereafter, if an Acknowledgement (ACK) for the ARQ block is received from the RS and an E2E ACK which provides a notification that the MS has received the ARQ block is received from the MS, for discarding the ARQ block from the queue;
the RS for transmitting the ARQ block to the MS and for transmitting the ACK for the ARQ block to the BS, if the ARQ block to be transmitted to the MS is received from the BS; and
the MS for transmitting the ACK for the ARQ block to the RS, for generating the E2E ACK, and for transmitting the E2E ACK to the BS, if the E2E-ARQ-Request message is received from the BS and the ARQ block is received from the RS.

24. The apparatus of claim 23, wherein the BS determines whether the MS leaves the handover region, and, if it is determined that the MS leaves the handover region, the BS completes the reception of the E2E ACK for the previously transmitted ARQ block, discards the ACK block stored in the queue, transmits an E2E-ARQ-Release message to at least one of the RS and the MS, and performs a process that is the same process as a process performed before the MS enters the handover region.

25. The apparatus of claim 23, wherein the MS checks whether an E2E-ARQ-Release message is received from the BS, and, if the E2E-ARQ-Release message is received, performs a process that is the same process as a process performed before the E2E-ARQ-Request message is received.
